(19) United States
(12) Patent Application Publication
(10) Pub. No.: US 2026/0122366 A1
(43) Pub. Date: Apr. 30, 2026

(54) IMAGING SYSTEM, CONTROL METHOD, AND STORAGE MEDIUM

(71) Applicant: CANON KABUSHIKI KAISHA, Tokyo (JP)

(72) Inventors: KOTOMI KAKIUCHI, Tokyo (JP); YOSUKE TAKAGI, Kanagawa (JP)

(21) Appl. No.: 19/306,062

(22) Filed: Aug. 21, 2025

(30) Foreign Application Priority Data
Oct. 28, 2024 (JP) 2024-189186

(51) Int. Cl. H04N 25/47; H04N 23/69; H04N 23/695; H04N 23/90

(52) U.S. Cl. CPC H04N 25/47; H04N 23/69; H04N 23/695; H04N 23/90

(57) ABSTRACT

Imaging systems, methods, and storage media are provided herein. One or more imaging systems may include a plurality of image pickup apparatuses, each of which may include one or more memories storing instructions and information on an operation of the plurality of image pickup apparatuses for each of a plurality of events, and one or more processors that, upon execution of the instructions, operate to determine, based on the information for each of the plurality of events, an image pickup apparatus for monitoring a start of a next event, and an image pickup apparatus for performing imaging.

### BACKGROUND

### Field of the Technology

The aspect of the disclosure relates to one or more embodiments of an imaging system, a control method, and a storage medium.

### Description of the Related Art

Systems using a plurality of cameras have conventionally been known, and, for example, Japanese Patent Application Laid-Open No. 2019-153986 discloses a surveillance system that performs surveillance using a plurality of cameras corresponding to a plurality of sub-areas obtained by dividing a wide area.

In the surveillance system disclosed in Japanese Patent Application Laid-Open No. 2019-153986, the cameras monitor an event and thus may miss scenes of an object to be captured. For example, in the case of a wedding, a plurality of cameras monitor the start of the event “entrance of the bride and groom,” and may focus on the bride and groom as targets, and miss scenes to be captured, such as guests in attendance chatting.

### SUMMARY

One or more embodiments of an imaging system according to one or more aspects of the disclosure may include a plurality of image pickup apparatuses. Each of the plurality of image pickup apparatuses may include one or more memories storing instructions and information on an operation of the plurality of image pickup apparatuses for each of a plurality of events, and one or more processors that, upon execution of the instructions, operate to determine, based on the information for each of the plurality of events, an image pickup apparatus for monitoring a start of a next event, and an image pickup apparatus for performing imaging. One or more methods corresponding to the above one or more imaging systems also constitute another aspect of the disclosure. A storage medium storing a program that causes a computer to execute the above one or more methods also constitutes another aspect of the disclosure.

Features of the disclosure will become apparent from the following description of embodiments with reference to the attached drawings. The following description of embodiments is described by way of example.

### BRIEF DESCRIPTION OF THE DRAWINGS

FIG. 1 illustrates the configuration of a camera system according to a first embodiment.

FIGS. 2A and 2B schematically illustrate a camera according to the first embodiment.

FIG. 3 is a block diagram illustrating the configuration of the camera according to the first embodiment.

FIG. 4 illustrates an example of an application screen displayed on an external device according to the first embodiment.

FIG. 5 is a flowchart illustrating an example of the operation of the camera according to the first embodiment.

FIG. 6 is a flowchart illustrating surveillance processing according to the first embodiment.

FIG. 7 is a flowchart illustrating imaging processing according to the first embodiment.

FIG. 8 illustrates the configuration of a camera system according to a second embodiment.

FIG. 9 is a flowchart illustrating surveillance processing according to the second embodiment.

FIG. 10 is a flowchart illustrating imaging processing according to the second embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the disclosure. Corresponding elements in respective figures will be designated by the same reference numerals, and a duplicate description thereof will be omitted.

In the following description, the camera system (imaging system) according to each embodiment is used for automatic imaging at a wedding ceremony. However, the disclosure is not limited to wedding ceremonies, and is applicable to any event or festival that requires monitoring of the start of an event and photography of an object.

### First Embodiment

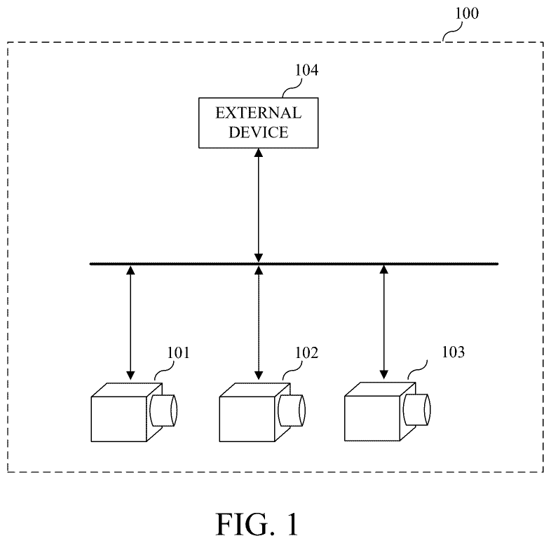

FIG. 1 illustrates the configuration of a camera system 100 according to this embodiment. The camera system 100 includes cameras (image pickup apparatuses) 101, 102, and 103, and an external device 104 that can communicate with each camera. The camera 101 is, for example, an automatic imaging camera that searches for an object by driving a pan/tilt-zoom. In this embodiment, the cameras 102 and 103 are the same model as the camera 101. The cameras 101, 102, and 103 may be the same model, but different models may be included. In this embodiment, the number of cameras in the camera system 100 is three, but the number is not limited to three. For example, it may be five, a dozen, or several tens.

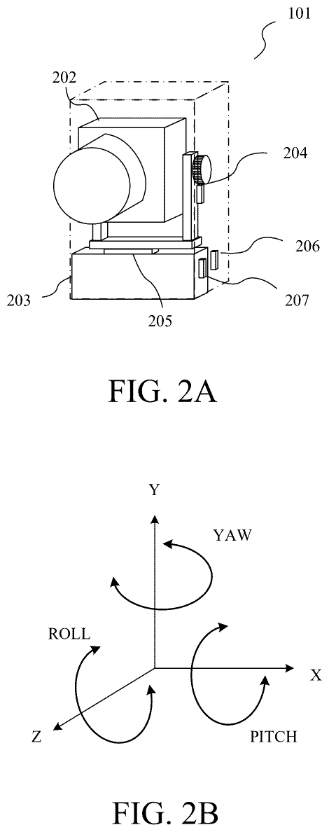

FIG. 2A illustrates a schematic diagram of the camera 101. FIG. 2B illustrates axis definition at the position of a fixed portion 203. The camera 101 includes an operation member capable of operating a power switch (referred to as a power button hereinafter, but operations such as tapping, flicking, and swiping on a touch panel may also be used). A lens barrel 202 is a housing including a lens unit and an image sensor. A tilt rotation unit 204 is a motor drive mechanism capable of rotating the lens barrel 202 in the pitch direction illustrated in FIG. 2B relative to the fixed portion 203. A pan rotation unit 205 is a motor drive mechanism capable of rotating the lens barrel 202 in the yaw direction illustrated in FIG. 2B relative to the fixed portion 203. Therefore, the lens barrel 202 can rotate in one or more axial directions. Both an angular velocity meter 206 and an accelerometer 207 are mounted on the fixed portion 203. Vibration of the camera 101 is detected based on the detection results by the angular velocity meter 206 and the accelerometer 207, and the tilt rotation unit 204 and the pan rotation unit 205 are driven based on information based on the detected vibration. Thereby, the shake and tilt of the lens barrel 202 can be corrected.

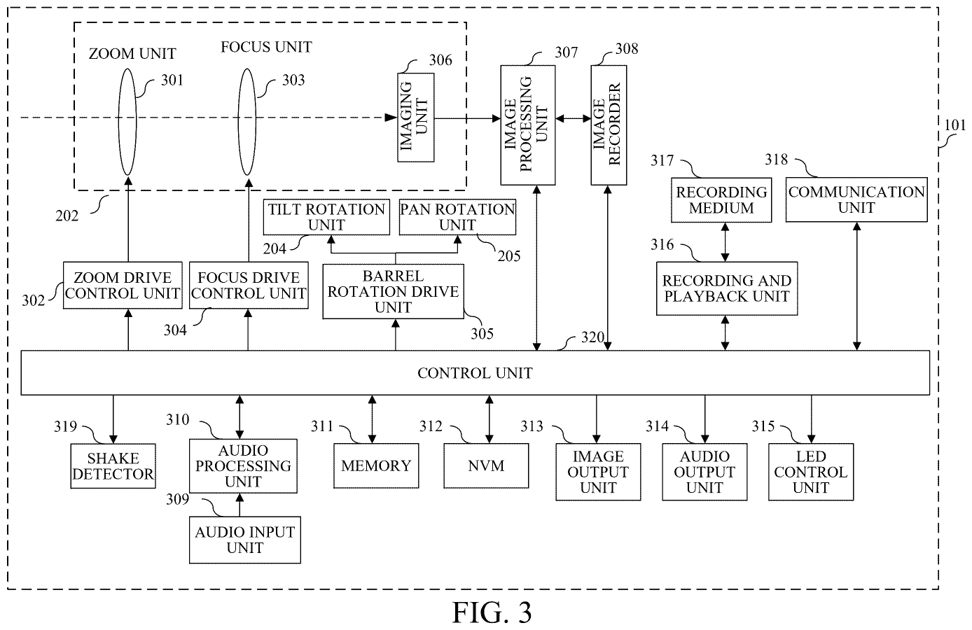

FIG. 3 is a block diagram illustrating the configuration of the camera 101. A control unit 320 includes one or more memories (e.g., DRAM, SRAM, etc.) storing instructions, and one or more processors (e.g., a CPU, GPU, microprocessor, MPU, etc.) that, upon execution of the instructions, operate to execute various processing to control each block of the camera 101 and to control data transfer between each block. A nonvolatile memory (NVM) (EEPROM) 312 is an electrically erasable and recordable memory, and stores constants and programs for the operation of the control unit 320.

A zoom unit 301 includes a zoom lens that performs magnification variation. A zoom drive control unit 302 drives and controls the zoom unit 301. A focus unit 303 includes a lens that performs focusing. A focus drive control unit 304 drives and controls the focus unit 303.

An imaging unit 306 includes an image sensor, which receives light incident through each lens unit and outputs as analog image data charge information corresponding to a light amount to an image processing unit 307. The image processing unit 307 applies image processing such as distortion correction, white balance adjustment, and color interpolation to digital image data output by A/D conversion, and outputs the digital image data after the processing. The digital image data output from the image processing unit 307 is converted into a recording format, such as JPEG format by an image recorder 308, and sent to a memory 311 and an image output unit 313. A lens barrel rotation drive unit 305 drives the tilt rotation unit 204 and the pan rotation unit 205 to rotate the lens barrel 202 in the tilt direction and the pan direction. A shake detector 319 includes, for example, an angular velocity meter (gyro sensor) 206 that detects the angular velocity of the camera 101 in three axial directions, and an accelerometer (acceleration sensor) 207 that detects the acceleration of the camera 101 in three axial directions. The shake detector 319 calculates a rotation angle and a shift amount of the camera 101 based on the detected signal.

An audio input unit 309 acquires audio signals from the surroundings of the camera 101 through a microphone provided on the camera 101, performs analog-to-digital conversion, and transmits them to an audio processing unit 310. The audio processing unit 310 performs audio processing such as optimizing the input digital audio signal. The audio signal processed by the audio processing unit 310 is transmitted to the memory 311 by the control unit 320. The memory 311 temporarily stores the image signal and audio signal obtained by the image processing unit 307 and the audio processing unit 310.

Each of the image processing unit 307 and the audio processing unit 310 reads out the image signal and audio signal temporarily stored in the memory 311, and performs encoding of the image signal and audio signal, respectively, to generate a compressed image signal and a compressed audio signal. The control unit 320 transmits the compressed image signal and compressed audio signal to a recording and playback unit 316.

The recording and playback unit 316 records the compressed image signal and compressed audio signal generated by the image processing unit 307 and audio processing unit 310, as well as other control data relating to imaging, into a recording medium 317. In a case where the audio signal is not compressed and encoded, the control unit 320 transmits the audio signal generated by the audio processing unit 310 and the compressed image signal generated by the image processing unit 307 to the recording and playback unit 316, which records them on the recording medium 317.

The recording medium 317 may be a recording medium built in the camera 101 or a removable recording medium. The recording medium 317 can record various data such as the compressed image signal, compressed audio signal, and audio signal generated by the camera 101, and a medium with a capacity larger than that of a nonvolatile memory 312 is generally used. For example, the recording medium 317 includes all types of recording media, such as a hard disk drive, an optical disc, a magneto-optical disk, CD-R, DVD-R, a magnetic tape, a nonvolatile semiconductor memory, and a flash memory.

The recording and playback unit 316 reads (plays back) the compressed image signal, compressed audio signal, audio signal, various data, and programs recorded on the recording medium 317. The control unit 320 transmits the read compressed image signal and compressed audio signal to the image processing unit 307 and audio processing unit 310. The image processing unit 307 and audio processing unit 310 temporarily store the compressed image signal and compressed audio signal in the memory 311, decode them in a predetermined procedure, and transmit the decoded signals to the image output unit 313 and an audio output unit 314.

The audio processing unit 310 can detect a direction of a sound on a plane on which a plurality of microphones are installed, and the detection result is used for object search and automatic imaging, which will be described later. The audio processing unit 310 also detects a specific audio command. The audio command may be a plurality of commands registered in advance, or may be a specific voice registered in the camera 101 by the user. The audio processing unit 310 also performs sound scene recognition. In sound scene recognition, a sound scene is determined using a network that has been trained by machine learning based on a large amount of audio data in advance. For example, a network configured to detect specific scenes such as “shout of joy,” “clapping,” and “voice sound” is set in the audio processing unit 310. The audio processing unit 310 also performs music recognition. In music recognition, a network that has been trained by machine learning based on a large amount of music data in advance determines music. The audio processing unit 310 is connected to a network for detecting specific music that has already been trained, and when it detects a specific sound scene, specific music, or specific voice command, it outputs a detection trigger signal to the control unit 320.

The audio output unit 314 outputs a previously set audio pattern from a speaker built in the camera 101, for example, during imaging.

An LED control unit 315 controls an LED provided in the camera 101, for example, during imaging, with a previously set lighting and blinking pattern.

The image output unit 313 is, for example, an image (video) output terminal, and transmits an image signal to display an image on a connected external display or the like. The audio output unit 314 and the image output unit 313 may be a single combined terminal, such as a High-Definition Multimedia Interface (HDMI) (registered trademark) terminal.

A communication unit 318 communicates between the camera 101 and the external device 104 that can communicate with it, and transmits and receives data such as an audio signal, an image signal, a compressed audio signal, and a compressed image signal. The communication unit 318 also receives a control signal relating to imaging, such as an imaging start and end command, and pan/tilt and zoom drive. Thereby, the camera 101 is driven based on an instruction from the external device 104. The communication unit 318 also receives event information from the external device 104, which is information on the operation of a plurality of cameras for a plurality of events. The event information may include schedule information indicating the order of events and information indicating the ID of an event monitoring camera. The event information may also include start trigger information for the next event and information indicating the imaging mode of the image pickup apparatus that performs imaging for each event. The memory 311 temporarily stores the received event information. It communicates with each other via the communication unit 318, and receives and transmits event start notifications (described later). The communication unit 318 is, for example, a wireless communication module such as an infrared communication module, a Bluetooth communication module, a wireless LAN communication module, a wireless USB, or a GPS receiver.

The camera 101 automatically captures an object that it has searched for by driving the pan/tilt and zoom, based on a predetermined condition. The predetermined condition is, for example, the current zoom magnification, and the general object recognition result or face detection result in the current imaging range. The predetermined condition may use the elapsed time from the last imaging, the sound level, etc.

The control unit 320 performs object search processing. First, the control unit 320 divides the area around the position of the camera 101. Next, the control unit 320 calculates an importance level indicating the priority order of the search for each divided area, according to the object present in the area and the scene situation of the area. The importance level according to the object's situation is calculated based on, for example, the number of objects present in the area, the face size, the face direction, and the certainty of face detection. The importance level according to the scene situation is calculated based on, for example, the general object recognition result, the scene discrimination result (blue sky, backlight, evening scene, etc.), the sound level from the direction of the area, the voice recognition result, and the motion detection information within the area.

Next, the control unit 320 determines the area with a high importance level as the search target area, and calculates a pan/tilt search target angle required to capture a search target area in an angle of view.

The control unit 320 then calculates a pan/tilt drive amount based on the pan/tilt search target angle, and performs pan/tilt drive. In a case where an object exists in the search target area, the control unit 320 calculates a zoom drive amount based on the object size in the object recognition image, and performs zoom drive.

The above processing can search for an object. While the object search is performed by pan/tilt drive and zoom drive, the object search may be performed by using a plurality of wide-angle lenses to perform imaging in all directions at once.

The camera 101 performs automatic imaging while changing an imaging method so that the optical axis of the camera 101 faces the object by rotating the lens barrel 202 using the control unit 320. Hereinafter, changing the imaging method each time the lens barrel 202 is rotated so that the optical axis of the camera 101 faces the object will be referred to as tracking. In tracking, the composition is adjusted to keep capturing the object. The composition adjustment calculates the pan/tilt zoom amount based on the position and size of the main object on the object recognition image, and drives the lens barrel rotation drive unit 305 and the zoom unit 301. The composition adjustment may use an Ultra Wide Band (UWB) tag. UWB is a term that refers to ultra-wideband wireless communication. UWB communication has the characteristic of enabling highly accurate position detection by using a very wide frequency band. In this case, information on the distance and direction between the camera 101 and the UWB tag is received using the UWB method via the communication unit 318. The control unit 320 then calculates the pan/tilt/zoom amounts from the distance and direction information, and drives the lens barrel rotation drive unit 305 and the zoom unit 301.

The camera 101 obtains event information in advance from the external device 104. The external device 104 is, for example, a computer, a tablet terminal, or a smartphone. This embodiment uses a computer as an example. The event information is input and set by the user on an application running on the external device 104.

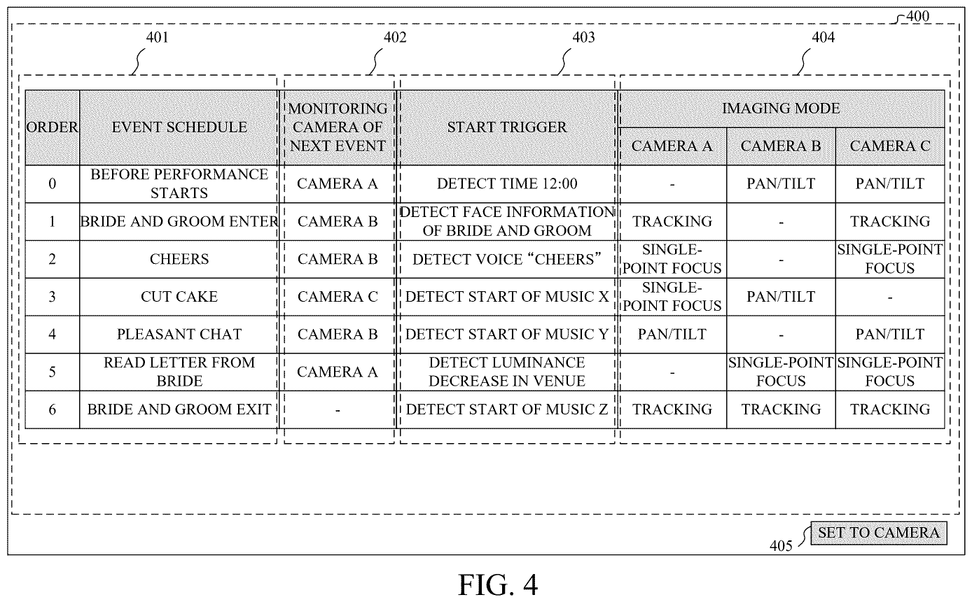

A method of setting event information to the camera 101 will be described below. FIG. 4 illustrates an example of an application screen for inputting and setting event information 400, which is displayed on the external device 104.

The camera 101 communicates with the external device 104 via the communication unit 318 using the HTTP communication method. The communication protocol is not limited to HTTP, and another communication protocol such as FTP may also be used.

When the user presses the setting button 405, the external device 104 sets the event information 400 to the camera 101 using an API provided for setting the event information 400 in the camera 101. Thereby, the external device 104 can set the event information in the camera 101.

The method of setting the event information 400 is not limited to this example. For example, the external device 104 may transmit the event information 400 created in a predetermined data format that the camera 101 can read to an external server or cloud service, and the camera 101 may access the external server or cloud service to read the event information 400. The external device 104 may set the event information 400 to a single camera using the API, and that single camera may transmit the event information 400 to the other cameras using the API.

The camera 101 performs an operation based on the set event information 400 for each event. More specifically, the camera 101 performs one of a monitoring operation for monitoring the start of an event and an imaging operation for imaging. In the monitoring operation, the camera 101 may perform an imaging operation in parallel with the monitoring operation. In this case, the monitoring operation is given priority over the imaging operation so as not to miss the start of the next event.

When the camera for the monitoring operation in the first event (referred to as a monitoring camera hereinafter) detects a start trigger indicating the start of the second event following the first event, it notifies the other camera of the start of the second event. When the second event starts, the monitoring camera is switched. More specifically, in the first event, the monitoring camera stops the monitoring operation and starts the imaging operation in the imaging mode for the second event. In the second event, the monitoring camera stops the imaging operation and starts the monitoring operation.

In this embodiment, the monitoring camera communicates with the other cameras via the communication unit 318 using the HTTP communication method. The communication protocol is not limited to HTTP, and another communication protocol such as FTP may be used.

As described above, when the monitoring camera detects the start of the next event (detects the start trigger of the next event), it transmits an event start notification to the other cameras using the API provided for transmitting and receiving the event start notification. The other cameras that receive the event start notification determine the next event based on the previously set event information 400, and perform the monitoring or imaging operation assigned to the next event. Through the above processing, the monitoring camera notifies the other cameras of the start of the next event. The method of event start notification is not limited to this example. For example, the monitoring camera may transmit an event start notification created in a predetermined data format that can be read by the other cameras to an external server or cloud service, and the other cameras may access the external server or cloud service to read the event start notification. In addition, the monitoring camera may transmit an event start notification to only one of the other cameras using the API, and the one camera may transmit an event start notification to the other cameras using the API.

The event information 400 set in each camera will be described below. Reference numeral 401 denotes schedule information indicating the order of the events. In this embodiment, for example, the events are “before the performance starts,” “the bride and groom enter,” “cheers,” “cut the cake,” “pleasant chat,” “read the letter from the bride,” and “the bride and groom exit.” Thus, the events and their order are set.

Reference numeral 402 denotes information (monitoring camera information) indicating which event each camera will monitor. In this embodiment, at the event “before the performance starts”, camera A monitors the start of the next event, “the bride and groom enter.” At the event “the bride and groom enter,” camera B monitors the start of the next event, “cheers.” At the event “cheers,” camera B monitors the start of the next event, “cut the cake.” At the event “cut the cake”, camera C monitors the start of the next event “pleasant chat.” At the event “pleasant chat,” camera B monitors the start of the next event, “read the letter from the bride.” At the event, “read the letter from the bride,” camera A monitors the start of the next event, “the bride and groom exit.” Thus, it is set which camera will monitor the start of the next event at each event. A plurality of monitoring cameras may be set. Using the plurality of monitoring cameras can detect the switching of events with higher accuracy than with a single monitoring camera. However, at least one camera is always performing an imaging operation so that a timing does not occur when all cameras are performing the monitoring operation. Similarly, at least one camera is always performing the monitoring operation so that a timing does not occur when all cameras are performing the imaging operation. In this case, the camera that first detects the start trigger notifies the other cameras of the start of the event.

Reference numeral 403 denotes start trigger information on a start trigger for detecting the start of the next event. The start trigger is, for example, detection of face information on a specified object, detection of a gesture of the object, detection of a specified voice, detection of a specified piece of music, arrival of a specified time, passage of a specified time, detection of luminance increase and decrease, etc. In this embodiment, it is “detect the time 12:00,” “detect face information on the bride and groom,” “detect the voice “cheers,” “detect the start of music X,” “detect the start of music Y,” “detect the luminance decrease in the venue,” and “detect the start of music Z.”

Thus, the start trigger information is set to each event. It is assumed that information necessary for detecting start triggers, such as face information on the bride and groom, and voice “cheers,” is previously set to the camera. A plurality of start triggers may be set to each event. For example, at least one of “detect voice ‘entry’” and “detect the start of entrance music” may be added as a start trigger to “the bride and groom enter.” This configuration can reduce the risk of overlooking or delaying the detection of an event change. In this case, when one start trigger is detected, the camera that detects the start trigger may notify the other cameras of the start of the event, or when a predetermined number or more start triggers are detected, the camera that last detected the start trigger may notify the start of the event.

Each camera may monitor a different start trigger. For example, camera A, which is closest to the entrance of the wedding hall, may monitor “detect face information on the bride and groom,” camera B, which is closest to the host, may monitor “detect voice ‘entry’,” and camera C, which is closest to the speaker in the hall, may monitor “detect the start of entrance music.” This configuration increases the accuracy of detecting event switching by having cameras suitable for detecting each start trigger monitor. In this case, if one of the monitoring cameras is set to notify the start of the event when it detects the corresponding start trigger, that camera can notify the other cameras of the start of the event. In a case where a predetermined number of cameras are set to notify the start of the event when they detect the corresponding start trigger, the camera that last detected the start trigger may notify the start of the event.

Reference numeral 404 denotes information (imaging mode information) indicating the imaging mode of the camera that performs the imaging operation for each event. The imaging mode is set for each camera and for each event. The camera 101 has three imaging modes, such as “pan/tilt mode,” “single-point focus mode,” and “tracking mode.” In this embodiment, for example, the “pan/tilt mode” is set to cameras B and C “before the performance starts.” Different imaging modes can be set for each camera during the same event. For example, during “cut the cake,” camera A can be set to the “single-point focus mode” to face the bride and groom and perform imaging, and camera B can be set to the “pan/tilt mode” to image the reactions of the surrounding guests.

The communication unit 318 also receives event information from the external device 104, which is information on the operation of the plurality of cameras for each of the plurality of events.

In this embodiment, the event information 400 includes schedule information 401, monitoring camera information 402, start trigger information 403, and imaging mode information 404, but the disclosure is not limited to this example as long as the information is related to the operation of the plurality of cameras for each of the plurality of events. The information on the operation of the plurality of cameras for each of the plurality of events is information that allows the plurality of cameras to operate properly for each of the plurality of events. For example, if the start trigger is specified by time, the event information 400 may include information on the operation of each camera for each event. Even if a different start trigger is specified for each event, if the monitoring camera transmits information indicating which event will be started when notifying the other cameras of the start of the event, the schedule information 401 may be omitted. If a single imaging mode is used, the imaging mode information 404 is not necessary if there is information indicating whether or not to perform the imaging operation.

The three imaging modes according to this embodiment will be described below. The “pan/tilt mode” is a mode in which the camera images the surroundings while searching for an object using pan/tilt drive and zoom drive, and is suitable for imaging guests chatting at a wedding, for example. In a case where an object is detected during pan/tilt drive, the camera stops searching for the object and images the object for a certain period of time, and then resumes pan/tilt drive after the certain period of time has elapsed. The certain period of time is, for example, 10 seconds. In order to image the surroundings uniformly, the camera may continue to image the object while continuing pan/tilt drive even if the object is detected.

The “single-point focus mode” is a mode in which the camera is directed in a target direction that is previously set to the camera, such as the entrance or the main seats for the bride and groom, and is suitable for imaging at noteworthy times, such as the moment when the bride and groom enter or the moment when the cake is cut. The target direction may be added or changed at any time from the application via the communication unit 318.

The “tracking mode” is a mode in which a moving object is tracked during imaging, and is suitable, for example, when the bride and groom enter and walk around the venue. As discussed above, tracking may be performed using an object recognition image, or may be performed using UWB communication by having the bride and groom carry UWB tags.

In this embodiment, the three imaging modes include the “pan/tilt mode,” the “single-point focus mode,” and the “tracking mode,” but the types and number of imaging modes are not limited to them.

In accordance with the above description, a series of operations performed by each camera in which the event information 400 in FIG. 4 is set will be described.

During the “before the performance” event, camera A monitors the start of the next event, “the bride and groom enter,” while cameras B and C perform imaging in the pan/tilt mode.

When camera A detects the face information on the bride and groom, it notifies cameras B and C of the start of the next event, “the bride and groom enter.” When the event switches to “the bride and groom enter,” cameras A and C perform imaging in the tracking mode, and camera B monitors the start of the next event, “cheers.”

When camera B detects the voice “cheers,” it notifies cameras A and C of the start of the next event, “cheers.” When the event switches to “cheers,” cameras A and C perform imaging in the single-point focus mode, and camera B monitors the start of the next event, “cut the cake.”

When camera B detects the start of music X, it notifies cameras A and C of the start of the next event, “cut the cake.” When the event switches to “cut the cake,” camera A performs imaging in the single-point focus mode, camera B performs imaging in the pan/tilt mode, and camera C monitors the start of the next event, “pleasant chat.”

When camera C detects the start of music Y, it notifies cameras A and B of the start of the next event, “pleasant chat.” When the event switches to “pleasant chat,” cameras A and C perform imaging in the pan/tilt mode, and camera B monitors the start of the next event, “read the letter from the bride.”

When camera B detects the luminance decrease in the venue, it notifies cameras A and C of the start of the next event, “read the letter from the bride.” When the event switches to “read the letter from the bride,” cameras B and C perform imaging in the single-point focus mode, and camera A monitors the start of the next event, “the bride and groom exit.”

When camera A detects the start of music Z, it notifies cameras B and C of the start of the next event, “the bride and groom exit.” When the event switches to “the bride and groom exit,” cameras A, B, and C perform imaging in the tracking mode. Since this is the last event, there will be no monitoring camera for the next event.

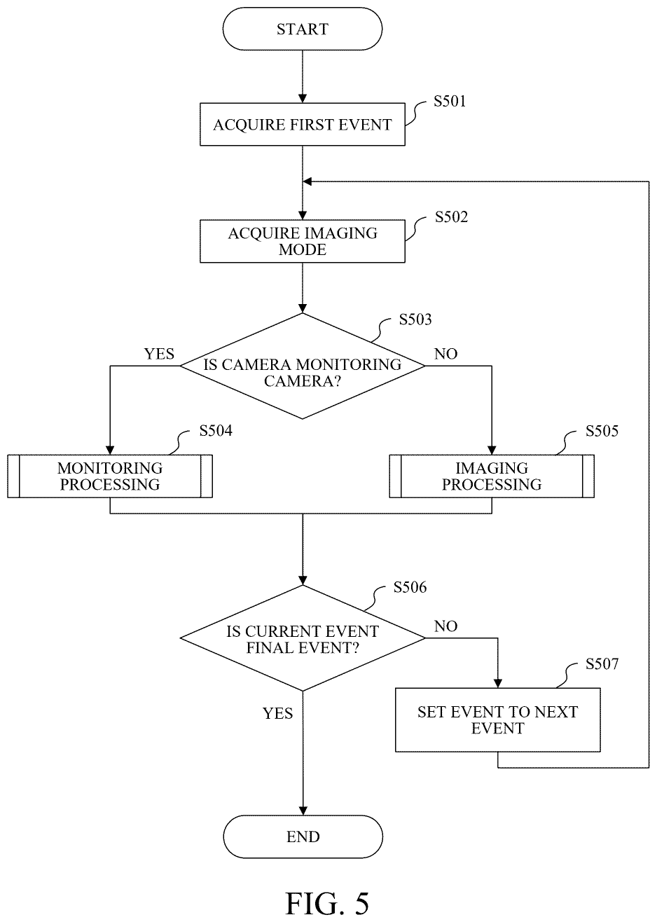

Referring now to FIG. 5, a description will be given of the overall flow of processing to be performed by each camera. FIG. 5 is a flowchart illustrating an example of the operation of each camera.

In step S501, the control unit 320 acquires the first event from the schedule information 401. In this embodiment, the first event is “before the performance starts.”

In step S502, the control unit 320 acquires the imaging mode from the imaging mode information 404. For example, in the case of camera B, the imaging mode for the event “before the performance starts” is the “pan/tilt mode.”

In step S503, the control unit 320 determines from the monitor information 402 whether the camera is a monitoring camera. In a case where the control unit 320 determines that the camera is a monitoring camera, it executes the processing of step S504, and in a case where it determines that the camera is not a monitoring camera, it executes the processing of step S505. For example, in the case of camera A, since it is a monitoring camera for the event “before the performance starts,” the control unit 320 executes the processing of step S504. For example, in the case of camera B, since it is not a monitoring camera for the event “before the performance starts,” the control unit 320 executes the processing of step S505.

In step S504, the control unit 320 performs monitoring processing.

In step S505, the control unit 320 performs imaging processing.

In step S506, the control unit 320 determines whether the current event is the final event. In a case where the control unit 320 determines that the current event is the final event, the flow ends, and in a case where it determines that the current event is not the final event, it executes the processing of step S507.

In step S507, the control unit 320 sets the event from the current event to the next event. For example, in a case where the current event is “before the performance starts,” it is not the final event, so the control unit 320 sets the event to the next event, “the bride and groom enter.”

Thus, the control unit 320 repeats the processing of steps S502 to S507 for each event until it is determined in step S506 that the event is the final event.

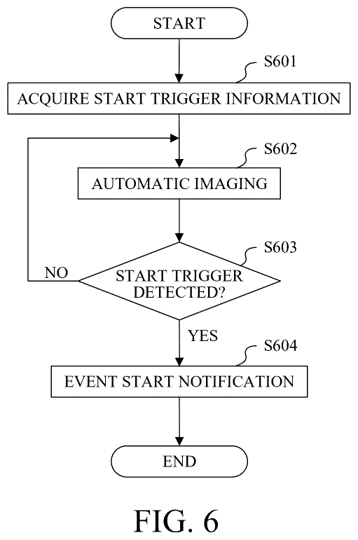

Referring now to FIG. 6, a description will be given of the monitoring processing. FIG. 6 is a flowchart illustrating the monitoring processing. Here, as an example, the processing performed by camera C, which is the camera monitoring the next event in a case where the current event is “cut the cake,” will be described.

In step S601, the control unit 320 acquires start trigger information 403. As described above, the start trigger is, for example, detection of face information on a specified object, detection of an object's gesture, detection of a specified sound, detection of a specified piece of music, arrival of a specified time, passage of a specified period of time, detection of the luminance increase and decrease, etc.

In step S602, the control unit 320 causes camera C to perform automatic imaging. In automatic imaging, as described above, the control unit 320 performs the pan/tilt drive and the zoom drive to perform object search processing, and automatically images the searched object based on the specified condition. Examples of the predetermined condition include the current zoom magnification, the general object recognition results, and face detection results in the current imaging range etc. The time elapsed since the previous imaging, the audio level, etc. may be used.

In step S603, the control unit 320 determines whether or not a start trigger has been detected. In a case where the control unit 320 determines that a start trigger has been detected, it executes the processing of step S604, and in a case where it determines that a start trigger has not been detected, it executes the processing of step S602. In a case where the control unit 320 detects the start of music Y, it executes the processing of step S604, and in a case where it has not detected the start of music Y, it executes the processing of step S602.

In step S604, the control unit 320 notifies the other cameras of the start of the next event. In a case where the control unit 320 detects the start of music Y in step S603, it notifies cameras A and B of the start of the next event, “pleasant chat,” via the communication unit 318.

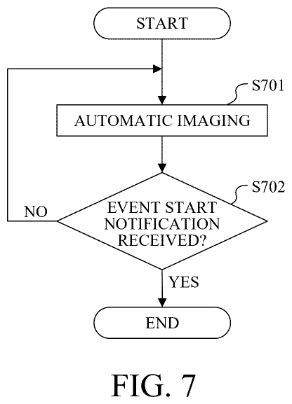

The imaging processing will be described below with reference to FIG. 7. FIG. 7 is a flowchart illustrating the imaging processing.

In step S701, the control unit 320 performs automatic imaging. In automatic imaging, as described above, the pan/tilt drive and the zoom drive are performed to automatically image an object searched for based on a predetermined condition.

In step S702, the control unit 320 determines whether an event start notification has been received from the monitoring camera. In a case where the control unit 320 determines that an event start notification has been received from the monitoring camera, the flow ends; otherwise, it executes the processing of step S701. For example, when the current event is “cheers” and the control unit 320 determines that cameras A and C have not received an event start notification from camera B, which is the monitoring camera, it continues automatic imaging; otherwise, the flow ends.

As described above, the camera system according to this embodiment switches the role of each camera for each event so that the camera suitable for each event monitors or performs imaging according to the progress of the event. Thereby, both monitoring the start of the event and imaging the object can be achieved.

This embodiment has discussed the method of setting the event information 400 from the external device 104, but the event information 400 may be set on any of the cameras included in the camera system. The camera system may also include an updater configured to update (or change) the schedule information in order to manage sudden changes in the schedule. For example, the camera may include an operation unit and a display unit for accepting instructions from the user, and may be able to set event information, add/delete, or change the order of schedule information, change start trigger information, and change imaging mode information. The operation unit may include, for example, a power button for the user to instruct the power-on/power-off, and an operation member such as a touch panel formed on the display unit. The display unit may include, for example, a member for displaying the event information 400, and displaying a setting button, a change button, a delete button, and the like for each piece of information. The camera may not include an operation unit or a display unit. For example, a computer, a tablet terminal, or a smartphone that can communicate with the camera may include the operation unit and the display unit. The camera may also be configured so that the imaging operation can be set to enabled or disabled for the monitoring camera. In order to reliably detect switching of the event, the imaging of the monitoring camera may be set to “disabled.” On the other hand, in a case where imaging is to be performed while an event is monitored, the imaging of the monitoring camera may be set to “enabled.”

### Second Embodiment

In the first embodiment, a monitoring camera that has detected the start of the next event directly notifies other cameras of the start of the event. However, in a case where the camera system includes a large number of cameras, it is inefficient to notify all of these cameras, and the notification processing may take time. In a case where the notification processing takes time, switching between the monitoring camera and the imaging camera may be delayed. Therefore, this embodiment will discuss a method in which a monitoring camera notifies other cameras of the start of an event via an application, so that event start notifications can be sent and received efficiently even if the camera system includes a large number of cameras.

The basic configuration of the camera system in this embodiment is the same as that of the camera system in the first embodiment. This embodiment will discuss only configurations that are different from the configuration in the first embodiment, and will omit a description of common configurations.

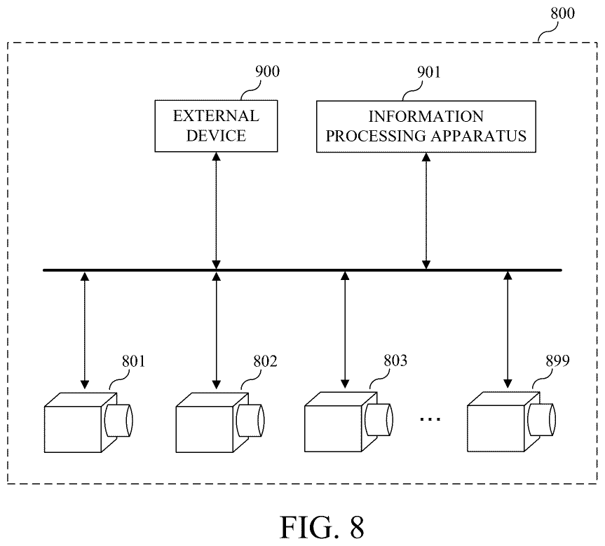

FIG. 8 illustrates the configuration of a camera system 800 according to this embodiment. The camera system 800 has 99 cameras 801, 802, 803,. 899, an external device 900, and an information processing apparatus 901. The cameras 801 to 899 have the same configuration as that of the camera 101 described in the first embodiment, and thus a detailed description thereof will be omitted. The external device 900 has the same configuration as that of the external device 104 described in the first embodiment, and thus a detailed description thereof will be omitted. In this embodiment, the number of cameras included in the camera system 800 is 99, but the number is not limited to this example.

The information processing apparatus 901 is a device for communicating with and controlling the camera 801. The information processing apparatus 901 is, for example, a computer, a tablet terminal, or a smartphone. In this embodiment, the information processing apparatus 901 is a smartphone as an example. The functions provided by the information processing apparatus 901 are achieved in the form of an application that runs on the information processing apparatus 901.

The information processing apparatus 901 is communicably connected to the monitoring camera and imaging camera via the same network using the HTTP communication method. Thereby, data can be sent and received between the information processing apparatus 901 and the monitoring camera, and between the information processing apparatus 901 and the imaging camera. Other communication protocols such as FTP may be used instead of HTTP.

The information processing apparatus 901 receives an event start notification from the monitoring camera, and transmits the event start notification to the other cameras. The function provided by the information processing apparatus 901 may be in the form of an application installed in the external device 900.

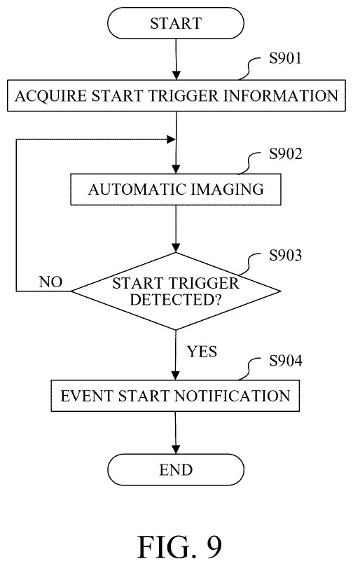

The monitoring processing performed by the camera according to this embodiment will be described below with reference to FIG. 9. FIG. 9 is a flowchart illustrating the imaging processing according to this embodiment. As described in the first embodiment, the monitoring processing is performed by the camera that is determined to be the monitoring camera based on the event information 400.

The processing of steps S901 to S903 is similar to the processing of steps S601 to S603, respectively, and thus a description thereof will be omitted.

In step S904, the control unit 320 notifies the information processing apparatus 901 of the start of the next event.

The information processing apparatus 901, which has received the next event start notification from the monitoring camera, transmits an event start notification to the other cameras.

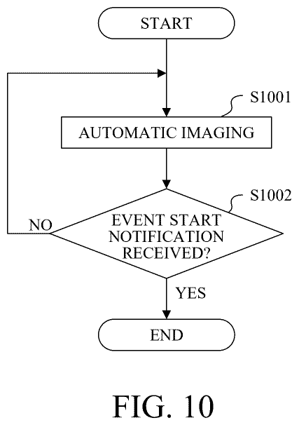

The imaging processing performed by the camera according to this embodiment will be described below with reference to FIG. 10. FIG. 10 is a flowchart illustrating the imaging processing according to this embodiment. As described in the first embodiment, the monitoring processing is performed by the camera that has been determined to perform imaging based on the event information 400.

The processing of step S1001 is similar to the processing of step S701, and thus a description thereof will be omitted.

In step S1002, the control unit 320 determines whether an event start notification has been received from the information processing apparatus 901. In a case where the control unit 320 determines that an event start notification has been received from the information processing apparatus 901, the flow ends; otherwise, it executes the processing of step S1001.

As explained above, since the monitoring camera notifies other cameras of the start of an event via an application, event start notifications can be sent and received efficiently even when the camera system includes a large number of cameras.

### Other Embodiments

Embodiment(s) of the disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the disclosure has been described with reference to embodiments, it is to be understood that the disclosure is not limited to the disclosed embodiments. The scope of the following claims is to be accorded the broadest interpretation so as to encompass all such modifications and equivalent structures and functions.

Each embodiment according to the disclosure can provide an imaging system that can achieve both monitoring of the start of an event and imaging of an object.

This application claims the benefit of Japanese Patent Application No. 2024-189186, which was filed on Oct. 28, 2024, and which is hereby incorporated by reference herein in its entirety.

What is claimed is:

1. An imaging system comprising:
a plurality of image pickup apparatuses,
wherein each of the plurality of image pickup apparatuses includes:
one or more memories storing instructions and information on an operation of the plurality of image pickup apparatuses for each of a plurality of events, and
one or more processors that, upon execution of the instructions, operate to determine, based on the information for each of the plurality of events, an image pickup apparatus for monitoring a start of a next event, and an image pickup apparatus for performing imaging.

2. The imaging system according to claim 1, wherein the information is changeable.

3. The imaging system according to claim 1, wherein in a case where the one or more processors in a first image pickup apparatus detect, in a first event, a start of a second event following the first event, the one or more processors operate to monitor a start of a third event following the second event, and a second image pickup apparatus different from the first image pickup apparatus performs imaging.

4. The imaging system according to claim 3, wherein in a case where the one or more processors in the first image pickup apparatus detect the start of the third event, the one or more processors operate to notify the second image pickup apparatus of the start of the third event.

5. The imaging system according to claim 3, further comprising a communication apparatus configured to communicate with each of the plurality of image pickup apparatuses,
wherein in a case where the one or more processors in the first image pickup apparatus detect the start of the third event, the one or more processors operate to notify the communication apparatus of the start of the third event, and the communication apparatus notifies the second image pickup apparatus of the start of the third event.

6. The imaging system according to claim 3, wherein the first image pickup apparatus is configured to set whether to enable or disable an execution of imaging in the second event.

7. The imaging system according to claim 1, wherein the information includes information indicating an imaging mode of an image pickup apparatus that performs imaging for each of the plurality of events.

8. The imaging system according to claim 3, wherein the second image pickup apparatus performs imaging in a first imaging mode.

9. The imaging system according to claim 8, wherein in a case where the start of the second event is detected, the one or more processors in a third image pickup apparatus different from the first image pickup apparatus and the second image pickup apparatus operate to perform an imaging operation in a second imaging mode different from the first imaging mode.

10. The imaging system according to claim 3, wherein a start trigger indicating the start of the second event is different from a start trigger indicating the start of the third event.

11. The imaging system according to claim 3, wherein in a case where the start of the second event is detected, the one or more processors in the first image pickup apparatus and the one or more processors in a fourth image pickup apparatus different from the first image pickup apparatus operate to monitor the start of the third event.

12. The imaging system according to claim 11, wherein in a case where the start of the second event is detected, the one or more processors in the first image pickup apparatus operate to monitor a first start trigger indicating the start of the third event, and
wherein the one or more processors in the fourth image pickup apparatus operate to monitor a second start trigger indicating the start of the third event, which is different from the first start trigger.

13. The imaging system according to claim 1, wherein the information includes schedule information indicating an order of the plurality of events, and
wherein each of the one or more processors in each of the plurality of image pickup apparatuses operate to determine the next event using the schedule information.

14. The imaging system according to claim 1, wherein the information includes information on an image pickup apparatus that monitors the start of the next event for each of the plurality of events.

15. The imaging system according to claim 1, wherein the information includes information on the start of a next event for each of the plurality of events.

16. A method for controlling an imaging system that includes a plurality of image pickup apparatuses, the method comprising:
determine, for each of a plurality of events, an image pickup apparatus for monitoring a start of a next event, and an image pickup apparatus for performing imaging, based on information on an operation of the plurality of image pickup apparatuses for each of the plurality of events stored by each of the plurality of image pickup apparatuses.

17. A non-transitory computer-readable storage medium storing a program that causes a computer to execute the method according to claim 16.
